(19) United States
(12) Patent Application Publication
(10) Pub. No.: US 2023/0162230 A1
(43) Pub. Date: May 25, 2023

(54) SYSTEMS AND METHODS FOR TARGETING CONTENT BASED ON IMPLICIT SENTIMENT ANALYSIS

(71) Applicant: Capital One Services, LLC, McLean, VA (US)

(72) Inventor: Paul Warner, Reston, VA (US)

(21) Appl. No.: 17/534,940

(22) Filed: Nov. 24, 2021

(51) Int. Cl. G06Q 30/02; G06N 5/04

(52) U.S. Cl. CPC G06Q 30/0255; G06Q 30/0201; G06N 5/042

(57) ABSTRACT

The disclosed technology relates to improved content deployment and orchestration to more effectively convert customers or users to paperless communication channels and facilitate increased digital engagement. An exemplary system may obtain user context data associated with a user following a trigger event. The system may then apply a trained machine learning model to the user context data to generate a likelihood score. The likelihood score may be indicative of a likelihood the user will enroll in a particular delivery option (e.g., paperless delivery) following the trigger event. Responsive to determining the likelihood score exceeds a threshold, the system may output content to the second user that may be identified based on a type of the trigger event and may be targeted to encourage enrollment in the delivery option. In addition to outputting the content, the system may be configured to establish orchestration for subsequent automated content delivery for the user.

### FIELD

The disclosed technology relates to systems and methods for deploying targeted digital content, and more particularly to improved digital content deployment based on implicit sentiment analysis of purchase transactions determined using machine learning.

### BACKGROUND

The deployment of digital content, including advertisements, by service providers to customers via web or mobile application interfaces, for example, is often not informed by the historical experience of a customer with a service provider, and is therefore less effective at achieving a goal of the content. For example, a service provider may target an advertisement with a unique benefit for a particular customer, to entice that customer to more fully engage in its service offerings, if it was aware of a declining or relatively negative sentiment for the customer with respect to the services offered by the provider. Alternatively, a customer with a relatively high sentiment with respect to the service provider may be provided different content that achieves a different business goal and does not offer a unique benefit that is less likely to be required in order to retain the customer.

Current sentiment analysis techniques for service providers include asking customers directly for feedback (e.g., via questionnaires) or monitoring unprompted customer feedback (e.g., via social media). Such explicit sentiment analysis are performed on textual data to help service providers monitor brand and product sentiment and to understand customer needs. For example, natural language processing (NLP) has been used to programmatically determine the positive of negative intent of a phrase based on cues, such as word choice and punctuation, for example.

However, relying on requested customer feedback is inefficient, ineffective, and requires trusting often inaccurate self-reporting. Additionally, monitoring unprompted customer feedback is unbalanced in that it may over-consider negative sentiment and be unable to associate positive sentiment with a portion of a customer base. Neither approach to sentiment analysis is holistic because it can only associate sentiment with a subset of customers (e.g., those returning a questionnaire or those posting comments on social media networks). Accordingly, there is currently no effective and efficient way for service providers to implicitly gauge customer experience or sentiment across a customer base, which can be used for a variety of business purposes including deployment of targeted digital content.

### BRIEF SUMMARY

Aspects of the disclosed technology include systems and methods for implicit sentiment analysis based on purchase transactions to facilitate deployment of targeted digital content. Sentiment analytics are improved in some examples of this technology by supervised training of a machine learning sentiment model based on transaction context data and prompted feedback or stored feedback data (e.g., sentiment ratings). The trained machine learning sentiment model may be deployed and applied to subsequent detected transactions (e.g., purchases) for a user to generate a transaction sentiment score for each of the transactions. The generated transaction sentiment score scan be used to update a stored user sentiment score for the user. Responsive to trigger events, such as a purchase or a successful web or mobile application login, the user sentiment score can be consulted to identify and deploy targeted digital content (e.g., an advertisement and/or hyperlink output to a graphical user interface of a web application). By more effectively targeting content (e.g., marketing placements), this technology can facilitate improved digital engagement, brand loyalty, and servicing for service provider (e.g., financial institution) associated with the transactions (e.g., credit card purchases).

The disclosed technology includes a system for implicit sentiment analysis to target content that includes one or more processors and memory in communication with the one or more processors and storing instructions that, when executed by the one or more processors, are configured to cause the system to perform one or more methods. For example, the system may generate and send a request via one or more first communication networks to a computing device associated with each of a plurality of first transactions. Responsive to receiving feedback data in response to each of the requests, the system may determine a first transaction sentiment score from the feedback data for each of the first transactions. The system may then train a sentiment model based on a correlation of first transaction context data obtained for each of the first transactions with a corresponding one of the first transaction sentiment scores. Responsive to verifying that an accuracy of the sentiment model exceeds an accuracy threshold, the system may apply the sentiment model to obtained second transaction context data associated with a second transaction to generate a second transaction sentiment score for the second transaction. The system also may insert at least a portion of the second transaction context data, the second transaction sentiment score, and a unique identifier for a user included in the second transaction context data into a record of a sentiment database. The system may then update A stored dynamic user sentiment score based on the second transaction sentiment score. The dynamic user sentiment score may be maintained in the sentiment database associated with the unique identifier for the user. Responsive to determining that the dynamic user sentiment score is within a score range, the system may automatically retrieve, and output to the user via one or more second communication networks, stored first digital content corresponding to the score range.

The disclosed technology includes another system for implicit sentiment analysis to target content that includes one or more processors and memory in communication with the one or more processors and storing instructions that, when executed by the one or more processors, are configured to cause the system to perform one or more methods. For example, the system may apply a stored sentiment model to obtained transaction context data associated with a transaction to generate a transaction sentiment score for the transaction. The system may then insert at least a portion of the transaction context data, the transaction sentiment score, and a unique identifier for a user included in the transaction context data into a record of a sentiment database. The system in this example may then update a stored user sentiment score based on the transaction sentiment score. The user sentiment score may be maintained in the sentiment database associated with the unique identifier for the user. The system may detect a login by the user via a mobile or web application. Responsive to determining that the user sentiment score exceeds a score threshold, the system may modify a graphical user interface to incorporate stored digital content selected based on the user sentiment score and output the modified graphical user interface for display via the mobile or web application.

The disclosed technology includes yet another system for implicit sentiment analysis to target content that includes one or more processors and memory in communication with the one or more processors and storing instructions that, when executed by the one or more processors, are configured to cause the system to perform one or more methods. For example, the system may apply a stored sentiment model to obtained transaction context data associated with a transaction to generate a transaction sentiment score for the transaction. The system in this example may then insert at least a portion of the transaction context data, the transaction sentiment score, and a unique identifier for a user included in the transaction context data into a record of a sentiment database. The system may update a stored dynamic user sentiment score based on the transaction sentiment score. The dynamic user sentiment score may be maintained in the sentiment database associated with the unique identifier for the user. Responsive to determining that the dynamic user sentiment score exceeds a score threshold, the system may retrieve, and output to the user via one or more communication networks, digital content selected based on the dynamic user sentiment score.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE DRAWINGS

FIG. 1 is a flow diagram of an example method 100 for training a sentiment model 490 based on transaction context data following detection of transactions, in accordance with an exemplary embodiment of the disclosed technology.

FIG. 2 is a flow diagram of an example method 200 for targeting and distributing content in response to trigger events and the application of a trained sentiment model 490, in accordance with another exemplary embodiment of the disclosed technology.

FIG. 3 is a block diagram of a network environment 400 that includes a service provider system 330, including a sentiment analysis system 310 and transaction processing system 320, according to certain exemplary implementations of the disclosed technology.

FIG. 4 is a block diagram of a service provider system 330, according to an exemplary implementation of the disclosed technology.

### DETAILED DESCRIPTION

Certain implementations of the disclosed technology may be utilized to automatically deliver content based on purchase sentiment to facilitate improved digital engagement and more effective, targeted marking, for example. A sentiment model 460 (e.g., a machine learning model) is trained based on transaction context data for users and associated feedback, which can be in the form of a rating that can correlate with a sentiment score for the transaction. The sentiment model 460 is then used to analyze transaction context data associated with subsequent transactions and generate a transaction sentiment score, which can be aggregated across transactions over time for a user to generate and update a user sentiment score. The user sentiment score reflects the purchase sentiment of a user, which may be reflective of their sentiment in relation to their financial services provider (e.g., credit card provider). For example, if a chargeback transaction occurs, that may be an indication of a negative purchasing experience that can negatively impact the sentiment score for a user.

The user sentiment scores can be used following trigger events for users to target particular content that corresponds to a user sentiment score or score range. The sentiment model 460 can be deployed in a service provider system 330 and applied following a marketing trigger event, such as a login via a web or mobile application by a user or generation of a statement for a user, for example. Accordingly, a service provider system 330 in some examples obtains transaction context data and applies the sentiment model 460 to the user context data to facilitate a correlation with the transaction context and feedback training data and determine a transaction sentiment score used to update a stored user sentiment score. Responsive to a trigger event for a user, the user sentiment score is consulted and digital content corresponding to the score is retrieved and provided for output. For example, if a successful login to a web application trigger event occurs for a user, a relatively negative user sentiment score may be retrieved from a sentiment database, and a banner advertisement for increased rewards points may be provided for output via an interface displayed following the successful login.

By leveraging machine learning to selectively target and deploy content based on purchase sentiment, the service provider device 330 may facilitate increased digital adoption and customer loyalty. Content encouraging or offering services or benefits can be deployed in an improved manner with this technology, including via orchestration and sequencing established in an effort to improve user transaction sentiment over time. Accordingly, implementations of the disclosed technology provide a more effective marketing approach for increased engagement and brand loyalty for service providers (e.g., financial service providers that facilitate purchase transactions).

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

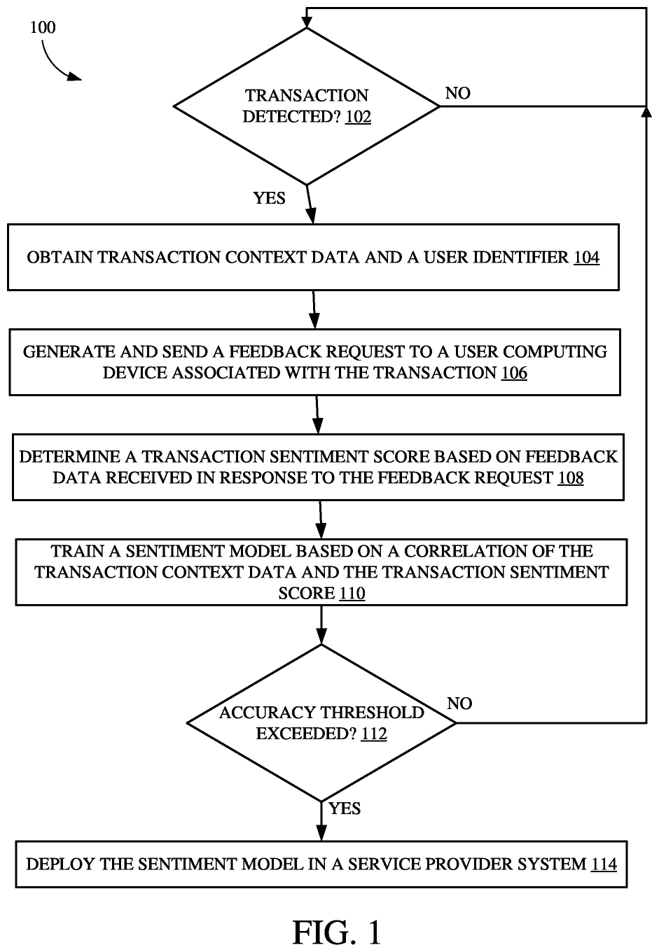

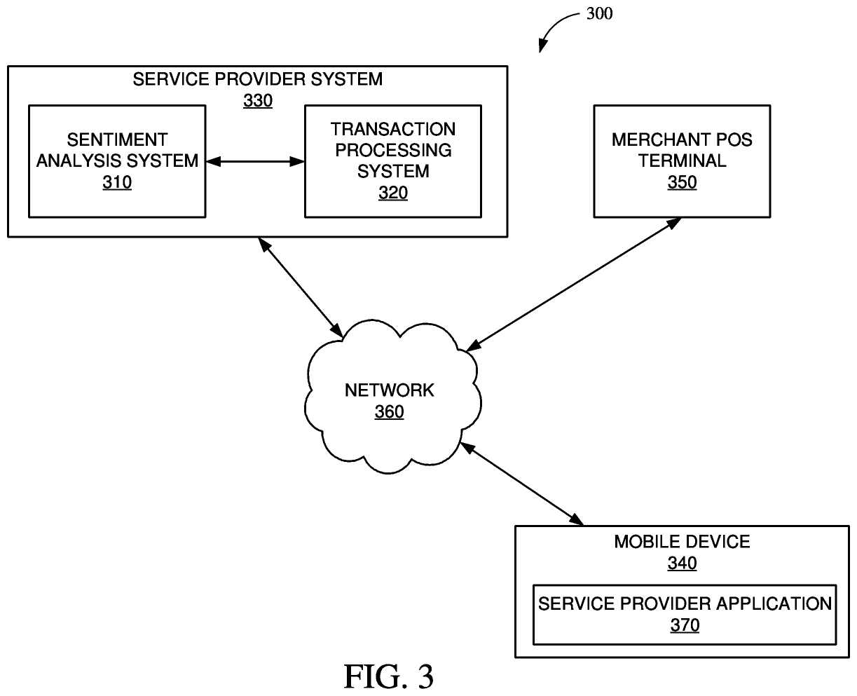

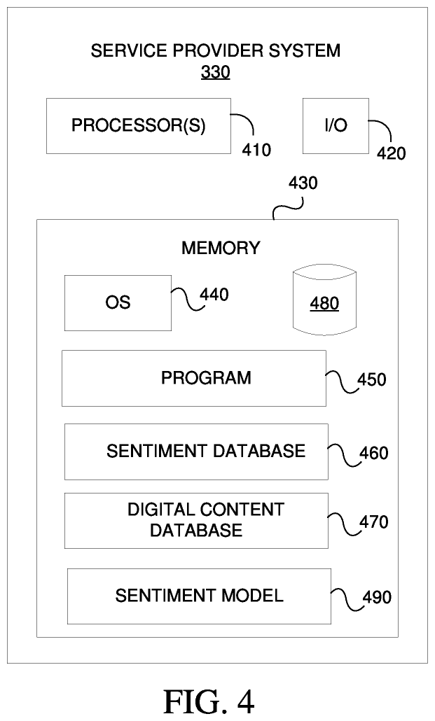

FIG. 1 is a flow diagram of an example method 100 for training a sentiment model 490 based on transaction context data following detection of transactions, in accordance with an exemplary embodiment of the disclosed technology. Method 100 may be performed by a system (e.g., an service provider system 330 and/or one or more subsystems thereof, such as a sentiment analysis system 310, as described in more detail below with respect to FIGS. 3-4). The system includes one or more processors 410 and memory 430 in communication with the one or more processors 410 and storing instructions. When executed by the one or more processors, the stored instructions cause the system to perform certain functions, such as one or more steps described and illustrated herein with reference to method 100 and/or method 200.

In block 102, the system may determine whether a transaction has been detected for a user (e.g., a customer of a service provider such as a financial institution). The transaction can be a purchase via a credit card, a chargeback, or a hold placed on a credit card (e.g., as a result of fraud), for example, although other types of purchases and/or transactions can be detected in block 102 in other examples. The system can monitor a device (e.g., transaction processing system 320, which can be an account management device that processes credit transactions) to determine when a transaction is initiated at that device.

In another example, the system can periodically scan a database (e.g., customer information database 480) to identify transaction(s) that have occurred since a previous database scan. Other methods for detecting transactions can also be used in other examples. If the system determines that a transaction has not been detected, then the No branch is taken back to block 102 and the system effectively waits to detect a transaction. However, if the system determines in block 102 that a transaction has been detected for at least one user, then the Yes branch is taken to block 104.

In block 104, the system may retrieve transaction context data associated with the transaction. One or more portions of the transaction context data can be obtained from a database of user information (e.g., customer information database 480) and/or can be generated by the system contemporaneously with respect to detecting the transaction. In some examples, the transaction context data can include a transaction type (e.g., a purchase or chargeback), a transaction category (e.g., a merchant category code), a transaction date, a transaction time, a transaction amount, a gratuity amount, an indication of a particular merchant associated with the transaction, a user identifier for a user associated with the transaction, a frequency of purchases by the user with respect to the merchant, and/or a cadence of the transaction for the user (e.g., one time or monthly) determined using the user identifier. Other types of transaction context data can also be used in other examples and portion(s) of the transaction context data can also be obtained from third party or external device(s).

In block 106, the system may generate and send a feedback request to a user computing device (e.g., mobile device 340) associated with the transaction. Contact information for the user associated with the transaction can be obtained via the user identifier and a query to the customer information database 480, for example. In one example, the feedback request is sent via a short message service (SMS) message to a mobile device phone number stored in the customer information database 480 associated with the user identifier obtained in block 104. In other examples, an e-mail or automated phone call or any other method of communication can be used for the feedback request, and other types of feedback requests can also be used. In some examples, the feedback request may provide an indication of the transaction and/or one or more portions of the transaction context data to inform or remind the user regarding the transaction.

In block 108, the system may determine a transaction sentiment score based on feedback data received in response to the feedback request. In one example, the feedback request may include a request for a rating for the transaction experience that is within an indicated scale. For example, the feedback request may request a rating on a scale of 0-10 with 10 being the most positive experience for the transaction. In this example, the transaction score can correspond to, or be generated based on, the rating value provided by the user in response to the feedback request. In other examples, the feedback request can require a qualitative rating that can be converted to a quantitative sentiment score based on an automated application of a set of rules.

In yet other examples, the system can be configured to override the feedback data to determine the sentiment score for certain types of transactions having predefined characteristics. For example, the system can apply a set of rules to the transaction context data to determine that when the transaction context data indicates a monthly cadence for the transaction, the sentiment score should be zero or neutral so as to have no impact on a dynamic user sentiment score generated from the transaction sentiment score as described and illustrated in more detail below. In this example, the system is configured to interpret an automated monthly bill payment, for example, as neutral (i.e., neither positive nor negative) with respect to a sentiment of the user. Other types of feedback requests, feedback data, and/or transaction sentiment scores can also be used in other examples.

In block 110, the system may train a sentiment model 490 based on a correlation and analysis of the transaction context data obtained in block 104 and the transaction sentiment score generated in block 108. In some examples, the sentiment model 490 can be a machine learning model that is updated by the system in block 110 based on the transaction context data and the transaction sentiment score. In this example, the sentiment model 490 is trained by analyzing trends and patterns for transaction context data and sentiment scores. For example, the sentiment model 460 may determine over time and during its training that transactions across users for a particular merchant tend to have higher sentiment scores irrespective of additional factors within the transaction context data that may differ between transactions.

The supervised training in some examples can use a neural network training algorithm while the sentiment model 490 is offline before being deployed in the system and/or subsequent to deployment in order to continually improve accuracy. Accordingly, the system may utilize deep learning model(s), such as a convolutional neural network (CNN) or long short-term memory (LSTM), for example. In other examples, the sentiment model 490 may be a binary classifier, such as a Support Vector Machine (SVM), Logistic Regression, Random Forest, or XGBoost, for example, and other types of machine learning models can also be used in other examples.

In block 112, the system may determine whether an accuracy threshold for the sentiment model 490 has been exceeded. In some examples, the system can automatically analyze the accuracy of the sentiment model 490 based on a database of synthetic transactions and associated transaction context data. In these examples, the accuracy of the sentiment model 490 can be based on a ratio of the number of correct predictions to the total number of input samples, with the ratio or percentage being configurable according to a desired tolerance. For example, the system may apply the sentiment model 490 to 50 synthetic transactions and associated transaction context data predefined to yield respective transaction sentiment scores. If the sentiment model 490 correctly predicts 45 of the 50 transaction sentiment scores, then the accuracy ratio is 90%, which can be compared against the configurable accuracy threshold to determine whether the sentiment model 490 is ready for deployment.

In other examples, other predefined transaction sentiment scores, number of synthetic transactions, and/or methods for analyzing accuracy of the sentiment model 490 can also be used. For example, logarithmic loss, confusion matrix, F1 score, mean absolute error, and/or mean squared error methods can also be used to evaluate accuracy in other examples. If the system determines in block 112 that the accuracy of the sentiment model 490 does not exceed the accuracy threshold, then the No branch is taken back to block 102 and the system continues training the sentiment model 490. However, if the system determines in block 112 that the accuracy threshold has been exceeded, then the Yes branch is taken to block 114.

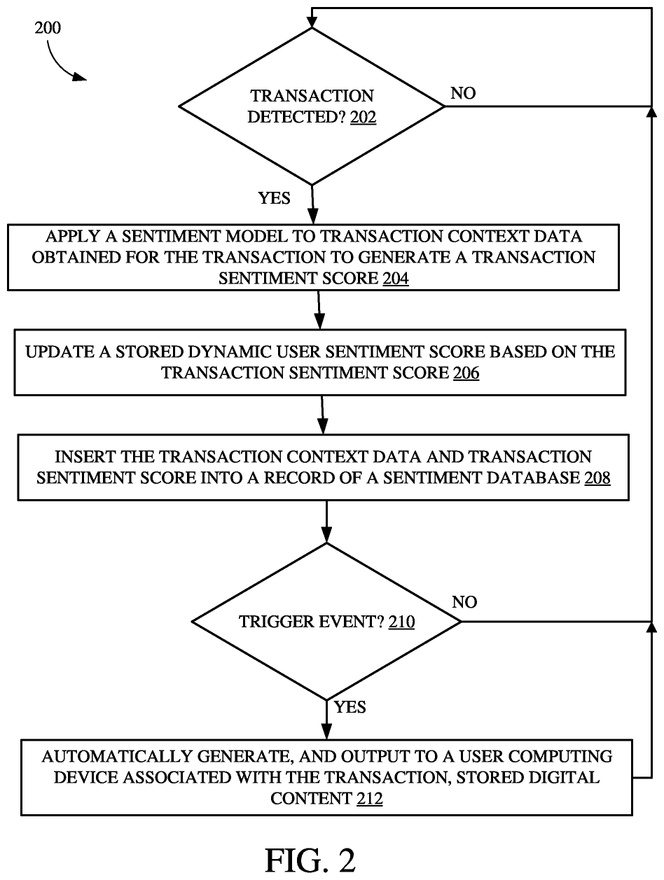

In block 114, the system may deploy the sentiment model 490, such as in the service provider system 330, for example. Accordingly, the deployed sentiment model 490 in this example is sufficiently trained to satisfy an accuracy threshold and will yield relatively accurate transaction sentiment score predictions that may improve the ability of the system to target digital content or services to users. The trained and deployed sentiment model 490 can be used by the system as described and illustrated below with reference to block 204 of FIG. 2, for example. Subsequent to deploying the sentiment model 490, the system can discontinue the training. In other examples, the system can proceed back to block 102 and continue training to improve accuracy subsequent to deployment. In yet other examples, the accuracy of the sentiment model 490 can be periodically tested using different input data and, if the accuracy falls below the accuracy threshold, the system can reinitiate the training.

In FIG. 2, a flow diagram is illustrated of an example method 200 for targeting and distributing content in response to trigger events and the application of a trained sentiment model 490, in accordance with another exemplary embodiment of the disclosed technology. Method 200 may be performed by a system (e.g., an service provider system 330 and/or one or more subsystems thereof, such as a sentiment analysis system 310, as described in more detail below with reference to FIGS. 3-4). The system includes processor(s) and memory in communication with the processor(s) and storing instructions. When executed by the processor(s), the stored instructions cause the system to perform certain functions, such as one or more steps described and illustrated herein with reference to method 200.

In block 202, the system may determines whether a transaction has been detected. The determination in block 202 can be the same as explained above with reference to block 102 of FIG. 1, for example. Alternatively, a transaction satisfying the condition in block 202 can be different than, and/or share only one or more characteristics with, another transaction that satisfies the condition in block 102. If the system determines that a transaction has not been detected, then the No branch is taken and the system proceeds back to block 202 and effectively waits for a transaction to be detected. However, if the system determines in block 202 that a transaction has been detected, then the Yes branch is taken to block 204.

In block 204, the system may apply a sentiment model 490 to obtained transaction context data for the transaction detected in block 202 to generate a transaction sentiment score. The applied sentiment model 490 can be generated and deployed as described and illustrated in detail above with reference to FIG. 1. Portion(s) of the transaction context data can be obtained from the customer information database 480 based on a unique identifier for the user associated with the transaction and can include any information corresponding to, or capable of being correlated with, the transaction context data described above with reference to block 104 and used to train the sentiment model 490.

The sentiment model 490 can be configured to use a distance metric in some examples, such as a cosine similarity, Euclidean, hamming, Manhattan, Chebyshev, or Minkowski technique, for analyzing the transaction context data, with the transaction sentiment score generated based on the distance metric, although the transaction sentiment score can be generated in other ways in other examples. The transaction sentiment score can be indicative of an experience of the user with respect to the detected transaction, although binary values and other types of transaction sentiment scores can also be used in other examples.

In block 206, the system may update a stored dynamic user sentiment score based on the transaction sentiment score generated in block 204. In a first example, the user sentiment score can be decreased by a first amount corresponding to the transaction sentiment score when the transaction sentiment score is a negative value as a result of the transaction being a merchant-initiated chargeback. In a second example, the user sentiment score can be decreased by a second amount, which corresponds to the transaction sentiment score and is greater than the first amount, when the transaction sentiment score is a negative value as a result of the transaction being an institution-initiated chargeback. The second amount can be greater than the first amount because the user's negative experience may be more attributable to the financial institution in the second example than the first example in which the chargeback was merchant-initiated (e.g., as a result of a return of a purchased item). Other types of transaction sentiment scores can be generated, and the dynamic user sentiment score can be updated in other ways in other examples.

In block 208, the system may store the transaction context data, transaction sentiment score, and/or current value of the dynamic user sentiment score, such as in a record associated with the user in a database (e.g., sentiment database 460). By storing the dynamic user sentiment score at various points in time in historical records of the sentiment database 460 in some examples, the snapshots can be used to determine a user sentiment score trend, an average user sentiment score over a trailing time period, and/or other metric(s) that can be used following a trigger event as explained below. Optionally, each of the historical records of the sentiment database 460 includes at least a unique identifier for a user, a transaction date or time, and the value of the dynamic user sentiment score when the record was inserted, although additional information can also be stored in one or more of the historical records in other examples.

In block 210, the system may determine whether a trigger event has occurred for at least one user. The trigger event in some examples may be a successful login via mobile or web application, an incoming phone call, or generation of a statement (e.g., a savings or credit account statement), although other types of trigger events can also be monitored in other examples. The trigger event in some examples is any event associated with a user that is a marketing opportunity for presenting marketing content to a user.

Accordingly, in some examples, the system can itself be, or can be integrated with, a marketing device that automatically places and deploys digital content following trigger events. In these examples, the system may be configured to monitor for the occurrence of a trigger event at the system or another networked device, or can be queried by such networked device for content to present to a user associated with the trigger event. If the system determines that a trigger event has not occurred, then the No branch is taken back to block 202. However, if the system determines in block 210 that a trigger event has occurred for at least one user, then the Yes branch is taken to block 212.

In block 212, the system may output content targeted or selected based on the dynamic user sentiment score stored in block 208. Optionally, the targeted content can be retrieved from the digital content database 470, although the targeted content can be retrieved from other sources in other examples. In some examples, the targeted content can be based on a type of the trigger event and a current dynamic user sentiment score. For example, if the type of the trigger event is a web application login, the targeted content can be a banner graphic capable of insertion into a graphical user interface output for display after the web application login. The graphic can have an associated hyperlink in the graphical user interface configured to link a user with a current dynamic user sentiment score below a predefined threshold to another webpage configured to allow the user to obtain a benefit (e.g., increased reward points or an introductory rate on a new loan account).

In another example, the digital content in the digital content database 470 can be associated with score ranges and selected for output when a dynamic user sentiment score within a corresponding one of the score ranges. In yet other examples, the system can identify the digital content based on a trend in the historical user sentiment scores for a user that indicates a rate of incline or decline above or below a predefined threshold, for example. While the particular example described and illustrated with reference to FIG. 2 results in the automated generation and output of digital content to a user computing device corresponding to a user associated with a detected trigger event, other actions can also be taken by the system in response to trigger events in other examples.

In particular, the system can automatically adjust for the user a credit line, an interest rate, or one or more rewards program parameters when the dynamic user sentiment score exceeds a score threshold (i.e., is above or below a predefined score threshold). The adjustments can be made via an automated communication with another networked device (e.g., an account management device storing account parameters for users). Other types of trigger events, ways of identifying digital content, and/or automated actions can also be taken by the system in other examples.

Subsequent to automatically generating and outputting the stored digital content in block 212 in the particular example described with reference to FIG. 2, the system proceeds back to block 202. In other examples, one or more of steps 202-212 can be performed by the system in a different order and/or in parallel (e.g., for any number of different users associated with detected transactions and/or trigger events). By targeting marketing content and/or services based on dynamic user sentiment scores, this technology facilitates an implicit sentiment analysis based on transaction (e.g., purchase) history that can reduce customer turnover and improve customer relationships and brand loyalty.

While the examples described and illustrated with reference to FIG. 2 focus on content and servicing directed to users based on dynamic user sentiment scores, in other examples, a vendor sentiment score can be determined for particular vendors that may be indicative of user experience with the vendors. In these examples, the transaction context data stored in block 208 can include an indication of a vendor associated with the transaction. Accordingly, the stored transaction sentiment scores for transactions associated with the vendor can be analyzed (e.g., aggregated or averaged) across any number of users to generate a vendor sentiment score that can be used in any number of automated ways by the system.

For example, a vendor sentiment score can be generated periodically for a vendor and, if the vendor sentiment score falls below a predefined threshold, the system can send an automated notification to a third party device associated with the vendor indicative of the decline in user purchase sentiment for transactions associated with the vendor. Additionally, the vendor sentiment score for a vendor can be output by the system to users to provide an automated recommendation service without requiring an explicit questionnaire (e.g., “would you recommend the vendor to a friend?”) or request for vendor feedback. The vendor sentiment score can also be used in other ways in other examples.

FIG. 3 is a block diagram of a network environment 300 that includes a service provider system 330, including a sentiment analysis system 310 and transaction processing system 320, according to certain exemplary implementations of the disclosed technology. The service provider system 330 (as will be discussed in more detail below with reference to FIG. 4) may include or be in communication with the transaction processing system 320 (e.g., associated with a financial service provider) and/or the sentiment analysis system 310. In certain implementations, the transaction processing system 320 may store and/or have access to detailed customer information, such as identifying information, user context data, user profiles, mobile device data, and/or transaction data, for example. The transaction processing system 320 in some examples is configured to process credit card transactions.

In accordance with certain exemplary embodiments, the transaction processing system 320 is configured to detect and process transactions, which the sentiment analysis system 310 evaluates with respect to targeted content deployment, as described and illustrated in detail above with reference to FIG. 2. While the sentiment analysis system 310 and transaction processing system 320 are illustrated in FIG. 3 as separate systems, the sentiment analysis system 310 and transaction processing system 320 can be integral with one another (e.g., with the sentiment analysis system 310 being implemented as a module or application executed by the transaction processing system 320). In other examples, the sentiment analysis system 310 is coupled to the transaction processing system 320 via the network 360 or another communications network and other configurations or network topologies can also be used in other examples.

In certain implementations, the mobile device 340 may be associated with a service provider customer (via the service provider system 330) and may host a service provider application 370 that is linked to the service provider system 330. The mobile device 340 may be a smart phone, tablet computer, smart wearable device, portable laptop computer, voice command device, wearable augmented reality device, or any other mobile computing device. The service provider application 370 can facilitate presentation of targeted content identified by the sentiment analysis system 310, such as in response to a trigger event corresponding to a successful login via the service provider application 370.

The merchant POS terminal 350 may be associated with an entity such as a vendor, merchant, business, corporation, individual, partnership, or any other entity that may be a seller of good and/or services. The merchant POS terminal 350 can communicate with the service provider system 330 via the network 360 to conduct a purchase transaction. Based at least in part on transaction data communicated by the merchant POS terminal 350, the sentiment analysis system 310 can analyze the purchase history and other transaction context data for users that can inform the deployment of targeted content and/or services, as explained in more detail above.

The network 360 may be of any suitable type, including individual connections via the Internet such as cellular or WiFi networks. In some implementations, the network 360 may enable the communication(s) between the various systems and devices as depicted in FIG. 3. In some embodiments, the network 360 may connect with the mobile device 340 using available channels, including but not limited to: radio-frequency identification (RFID), near-field communication (NFC), Bluetooth™, low-energy Bluetooth™ (BLE), WiFi™, ZigBee™, ambient backscatter communications (ABC) protocols, USB, Ethernet, or LAN. In some embodiments, data can be transmitted across the network 360 in either an encrypted or un-encrypted format. The network 360 can comprise a mobile network interface that provides access to a cellular network, the Internet, or another wide-area network. In some embodiments, a mobile network interface may include hardware, firmware, and/or software that allows one or more processors to communicate with other devices via wired or wireless networks, whether local or wide area, private or public, as known in the art.

As described above, the sentiment analysis system 310, transaction processing system 320, and any of the other devices depicted in the network environment 300 may be configured to remotely communicate with one another and may include one or more of a microprocessor, microcontroller, digital signal processor, co-processor, memory, or the like or combinations thereof capable of executing stored instructions and operating upon stored data. The memory may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, hard disks, flash memory, a redundant array of independent disks (RAID), solid state drives (SSDs), and the like), for storing files including an operating system, application programs (including, for example, a web browser application or other applications, as necessary), executable instructions and data. In one embodiment, the processing techniques described herein are implemented as a combination of executable instructions and data within the memory.

The network environment 300 may include one or more storage devices configured to store information used by one or more processors (or other components) to perform certain functions related to the disclosed embodiments. In one example, the network environment 300 may include memory storing instructions to enable one or more processors to execute one or more applications, such as server applications, network communication processes, and any other type of application or software known to be available on computer systems. Alternatively, the instructions, application programs, etc. may be stored in an external storage or available from a memory over the network 360. The one or more storage devices may be volatile or non-volatile, magnetic, semiconductor, tape, optical, removable, non-removable, or other type of storage device or tangible, non-transitory computer-readable medium.

In one embodiment, the network environment 300 may include memory that includes instructions that, when executed by one or more processors (e.g., processors of one or more devices of the service provider system 330), perform one or more processes consistent with the functionalities disclosed herein. Methods, systems, and articles of manufacture consistent with disclosed embodiments are not limited to separate programs or computers configured to perform dedicated tasks.

The network environment 300 may also be communicatively connected to one or more memory devices (e.g., databases (not shown)) locally or through the network 360. The remote memory devices may be configured to store information and may be accessed and/or managed by the service provider system 330. By way of example, the remote memory devices may be document management systems, Microsoft® SQL databases, SharePoint® databases, Oracle® databases, Sybase™ databases, Postgres, MariaDB®, Couchbase™, Redis™, MongoDB® or other relational or non-relational databases. Systems and methods consistent with disclosed embodiments, however, are not limited to separate databases or even to the use of a database.

In exemplary embodiments of the disclosed technology, the network environment 300 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

In some embodiments, one or more web applications may be utilized by the network environment 300, for example, to interface with the mobile device 340. In certain implementations, the one or more web applications may include one or more web components. A rendered web component, for example, may be at least partially insulated from styles or variables that are defined outside of the web component, it can easily be copied and embedded in a wide variety of different types of code and applications, while preserving its general functionality. Web components may be programmed in a client-side programming language such as JavaScript, although this is not a requirement. Any suitable client-side programming language or software language can also be used.

FIG. 4 is a block diagram of the service provider system 330 according to an exemplary implementations of the disclosed technology. The service provider system 330 may have a similar structure and functions as depicted and described above with respect to FIG. 3. The service provider system 330 may include processor(s) 410, an input/output (I/O) device 420, a memory 430 containing an operating system (OS) 440, a program 450, a sentiment database 460, a digital content database 470, and a sentiment model 490. For example, the service provider system 330 may be a single server or may be configured as a distributed computer system including multiple servers or computers that interoperate to perform one or more of the processes and functionalities associated with the disclosed embodiments. In some embodiments, the service provider system 330 may further include a peripheral interface, a transceiver, a mobile network interface in communication with the processor(s) 410, a bus configured to facilitate communication between the various components of service provider system 330, and a power source configured to power one or more components of the service provider system 330.

The processor(s) 410 may be one or more known processing devices, such as a microprocessor from the Pentium family manufactured by Intel™ or the Turion™ family manufactured by AMD™. The processor(s) 410 may constitute a single core or multiple core processor that executes parallel processes simultaneously. For example, the processor(s) 410 may be a single core processor that is configured with virtual processing technologies. In certain embodiments, the processor(s) 410 may use logical processors to simultaneously execute and control multiple processes. The processor(s) 410 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

The service provider system 330 may include or be in communication with one or more peripheral interfaces and may include the hardware, firmware and/or software that enables communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

According to an example implementation of the disclosed technology, service provider system 330 includes a memory 430 that may store one or more programs 450 to perform one or more functions of the disclosed embodiments. The memory 430 may include one or more memory devices that store data and instructions used to perform one or more features of the disclosed embodiments. The memory 430 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 430 may include software components that, when executed by processor(s) 410, perform one or more processes consistent with the disclosed embodiments.

While the service provider system 330 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the service provider system 330 may include a greater or lesser number of components than those illustrated.

### EXAMPLE USE CASE

The following example use case describes an example of a typical user flow pattern. This section is intended solely for explanatory purposes and not in limitation.

In one example, three transactions occur with respect to a credit account for a particular user that are detected by the service provider system 330. The first transaction is a purchase of a product, which is determined based on transaction context data to be a one-time purchase. The service provider system 330 applies the sentiment model 490, which is trained as described above with reference to FIG. 1, to generate a sentiment score of 100, which is stored in the sentiment database 460 as the current dynamic user sentiment score for the user. The second transaction is a purchase of a service, which is determined to be a monthly recurring expense by the service provider system 330 based on the transaction context data. Upon the application of the sentiment model 490, the service provider system 330 generates a transaction sentiment score of 0, which therefore has no impact on the dynamic user sentiment score for the user.

The third transaction is determined by the service provider system 330 to be an institution-initiated chargeback based on the transaction context data. The institution-initiated chargeback can reflect a fraudulent transaction or mistake on the part of the financial services provider that issued the credit card. The service provider system 300 applies the sentiment model to the third transaction yielding a transaction sentiment score of 20. In this example, the service provider system 330 averages the transaction sentiment scores of 100 and 20 to generate a dynamic user sentiment score of 60, which is stored in the sentiment database 460.

Subsequently, the user may login via the mobile device 340 to the service provider application 370 provided by the financial services provider. Upon detecting the successful login trigger event, the service provider system 330 determines that the user has a relatively low current dynamic user sentiment score in the sentiment database 460 of 60, which falls within a 50-70 score range. The service provider system 330 then retrieves content that is associated with the 50-70 score range from the digital content database 470. The content is a graphical advertisement for increased rewards points on entertainment purchases for the next 12 months and links to an interface selectable by the user via the service provider application 370. The service provider system then embeds the content into an interface and serves the interface via the network 360 and the service provider application 370 in response to the successful login by the user.

Accordingly, the targeted content is output via incorporation into a predefined location of a graphical user interface of the service provider application 370 provided to the mobile device 340 following the successful login. The user in this particular exemplary use case may then select the targeted content, submits a request to accept the offer of increased rewards points via another graphical user interface output following the selection, and the service provider system 330 processes the request to update an indication in a record of the customer information database 480 for the user to indicate that the user's reward points should now be calculated in accordance with the accepted offer. By providing the offer to the user with relatively low or negative sentiment with respect to their purchase history associated with the financial services provider, the user may be more likely to remain a customer and improve their sentiment towards their purchase history and, by extension, their financial services provider.

In some examples, disclosed systems or methods may involve one or more of the following clauses:

Clause 1: A system for implicit sentiment analysis to target content, the system comprising: one or more processors; and memory in communication with the one or more processors and storing instructions that, when executed by the one or more processors, are configured to cause the system to: generate and send a request via one or more first communication networks to a computing device associated with each of a plurality of first transactions; responsive to receiving feedback data in response to each of the requests, determine a first transaction sentiment score from the feedback data for each of the first transactions; train a sentiment model based on a correlation of first transaction context data obtained for each of the first transactions with a corresponding one of the first transaction sentiment scores; responsive to verifying that an accuracy of the sentiment model exceeds an accuracy threshold, apply the sentiment model to obtained second transaction context data associated with a second transaction to generate a second transaction sentiment score for the second transaction; insert at least a portion of the second transaction context data, the second transaction sentiment score, and a unique identifier for a user included in the second transaction context data into a record of a sentiment database; update a stored dynamic user sentiment score based on the second transaction sentiment score, wherein the dynamic user sentiment score is maintained in the sentiment database associated with the unique identifier for the user; and responsive to determining that the dynamic user sentiment score is within a score range, automatically retrieve, and output to the user via one or more second communication networks, stored first digital content corresponding to the score range.

Clause 2: The system of clause 1, wherein the instructions, when executed by the one or more processors, are further configured to cause the system to, responsive to detecting a login by the user via a mobile or web application, modify a default graphical user interface to incorporate the stored first digital content to output the stored first digital content corresponding to the score range.

Clause 3: The system of clause 1, wherein the instructions, when executed by the one or more processors, are further configured to cause the system to determine that the dynamic user sentiment score is within the score range based on a sentiment trend determined based on a plurality of stored historical user sentiment scores for the user.

Clause 4: The system of clause 1, wherein the second transaction context data comprises a type of the second transaction and wherein the type of the second transaction comprises a chargeback.

Clause 5: The system of clause 4, wherein the instructions, when executed by the one or more processors, are further configured to reduce the dynamic user sentiment score by a first value to update the dynamic user sentiment score, when the chargeback is a merchant-initiated chargeback.

Clause 6: The system of clause 5, wherein the instructions, when executed by the one or more processors, are further configured to reduce the dynamic user sentiment score by second value to update the dynamic user sentiment score, when the chargeback is an institution-initiated chargeback, wherein the second value is greater than the first value.

Clause 7: The system of clause 1, wherein the second transaction context data further comprises one or more of an indication of a merchant, a transaction category, a transaction type, a transaction date, a transaction time, a transaction amount, or a gratuity amount.

Clause 8: The system of clause 1, wherein the second transaction context data comprises an indication of a merchant and a type of the second transaction, wherein the type of the second transaction comprises a purchase, and wherein the instructions, when executed by the one or more processors, are further configured to determine a frequency of purchases by the user with respect to the merchant based on third transaction context data in a plurality of historical records associated with the user in the sentiment database.

Clause 9: The system of clause 8, wherein the model is configured to generate a positive transaction sentiment score based on the frequency.

Clause 10: The system of clause 8, wherein the model is configured to generate a neutral transaction sentiment score when the frequency comprises a monthly cadence.

Clause 11: The system of clause 1, wherein the instructions, when executed by the one or more processors, are further configured to, responsive to determining that the dynamic user sentiment score exceeds a score threshold, automatically adjust for the user one or more of a credit line, an interest rate, or one or more rewards program parameters.

Clause 12: The system of clause 1, wherein the instructions, when executed by the one or more processors, are further configured to generate an average user sentiment score for the user for a trailing time period based on the second transaction sentiment score and a plurality of third transaction sentiment scores in third transaction context data in a plurality of historical records in the sentiment database, wherein each of the historical records comprises the unique identifier for the user and a transaction date or time that is within the trailing time period.

Clause 13: The system of clause 12, wherein the instructions, when executed by the one or more processors, are further configured to, responsive to determining that the average user sentiment score exceeds a score threshold, automatically retrieve, and output to the user via the one or more second communication networks, stored second digital content.

Clause 14: A system for implicit sentiment analysis to target content, the system comprising: one or more processors; and memory in communication with the one or more processors and storing instructions that, when executed by the one or more processors, are configured to cause the system to: apply a stored sentiment model to obtained transaction context data associated with a transaction to generate a transaction sentiment score for the transaction; insert at least a portion of the transaction context data, the transaction sentiment score, and a unique identifier for a user included in the transaction context data into a record of a sentiment database; update a stored user sentiment score based on the transaction sentiment score, wherein the user sentiment score is maintained in the sentiment database associated with the unique identifier for the user; detect a login by the user via a mobile or web application; and responsive to determining that the user sentiment score exceeds a score threshold: modify a graphical user interface to incorporate stored digital content selected based on the user sentiment score; and output the modified graphical user interface for display via the mobile or web application.

Clause 15: The system of clause 14, wherein the instructions, wherein the instructions, when executed by the one or more processors, are further configured to cause the system to: generate and send a request via one or more communication networks to computing device associated with a plurality of received transactions; responsive to receiving feedback data in response to the requests, determine transaction sentiment scores from the feedback data for the received transactions; and generate and store the sentiment model based on a correlation of additional transaction context data obtained for the transactions with a corresponding one of the transaction sentiment scores.

Clause 16: The system of clause 14, wherein the instructions, wherein the instructions, when executed by the one or more processors, are further configured to cause the system to determine that the user sentiment score exceeds a score threshold based on a sentiment trend determined based on a plurality of stored historical user sentiment scores for the user.

Clause 17: The system of clause 14, wherein the instructions, when executed by the one or more processors, are further configured to: reduce the user sentiment score by a first value to update the user sentiment score, when a type of the transaction is a merchant-initiated chargeback; and reduce the user sentiment score by a second value to update the user sentiment score, when the type of the transaction is an institution-initiated chargeback, wherein the second value is greater than the first value.

Clause 18: A system for implicit sentiment analysis to target content, the system comprising: one or more processors; and memory in communication with the one or more processors and storing instructions that, when executed by the one or more processors, are configured to cause the system to: apply a stored sentiment model to obtained transaction context data associated with a transaction to generate a transaction sentiment score for the transaction; insert at least a portion of the transaction context data, the transaction sentiment score, and a unique identifier for a user included in the transaction context data into a record of a sentiment database; update a stored dynamic user sentiment score based on the transaction sentiment score, wherein the dynamic user sentiment score is maintained in the sentiment database associated with the unique identifier for the user; responsive to determining that the dynamic user sentiment score exceeds a score threshold, retrieve, and output to the user via one or more communication networks, digital content selected based on the dynamic user sentiment score.

Clause 19: The system of clause 18, wherein the instructions, wherein the instructions, when executed by the one or more processors, are further configured to cause the system to: determine that the dynamic user sentiment score exceeds the score threshold after detecting a login by the user via a mobile or web application; and modify a graphical user interface to incorporate the digital content and, output the modified graphical user interface for display via the mobile or web application, to output the digital content to the user.

Clause 20: The system of clause 18, wherein the instructions, wherein the instructions, when executed by the one or more processors, are further configured to cause the system to: generate and send a request via one or more communication networks to computing device associated with a plurality of transactions; responsive to receiving feedback data in response to the requests, determine transaction sentiment scores from the feedback data for the transactions; and generate and store the sentiment model based on a correlation of additional transaction context data obtained for the transactions with a corresponding one of the transaction sentiment scores.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for implicit sentiment analysis to target content, the system comprising:
one or more processors; and
memory in communication with the one or more processors and storing instructions that, when executed by the one or more processors, are configured to cause the system to:
generate and send a request via one or more first communication networks to a computing device associated with each of a plurality of first transactions;
responsive to receiving feedback data in response to each of the requests, determine a first transaction sentiment score from the feedback data for each of the first transactions;
train a sentiment machine learning model based on a correlation of first transaction context data obtained for each of the first transactions with a corresponding one of the first transaction sentiment scores determined from the feedback data;
responsive to verifying that an accuracy of the sentiment machine learning model exceeds an accuracy threshold, apply the trained sentiment machine learning model to obtained second transaction context data associated with a second transaction conducted by a user to generate a second transaction sentiment score for the second transaction;
insert at least a portion of the second transaction context data, the second transaction sentiment score, and a unique identifier for the user included in the second transaction context data into a record of a sentiment database;
update a stored dynamic user sentiment score for the user based on the second transaction sentiment score for the second transaction conducted by the user, wherein the dynamic user sentiment score is maintained in the sentiment database associated with the unique identifier for the user;
responsive to detecting a login by the user via a mobile or web application:
generate a default graphical user interface (GUI);
responsive to determining that the dynamic user sentiment score is outside of a score range, output the default GUI via the mobile or web application; and
responsive to determining that the dynamic user sentiment score is within the score range, automatically:
modify the default GUI to include stored first digital content corresponding to the score range and targeted to the user to generate a modified GUI, wherein the first digital content comprises a graphic and a hyperlink that is selectable by a user interface device to direct the user to another webpage associated with a host of the mobile or web application; and
output the modified GUI via the mobile or web application.

2. (canceled)

3. The system of claim 1, wherein the second transaction context data comprises a type of the second transaction and wherein the type of the second transaction comprises a chargeback.

4. A system for implicit sentiment analysis to target content, the system comprising:
one or more processors; and
memory in communication with the one or more processors and storing instructions that, when executed by the one or more processors, are configured to cause the system to:
train a sentiment machine learning model based on a correlation of first transaction context data obtained for each of a plurality of first transactions with a corresponding one of a plurality of first transaction sentiment scores determined from feedback data for each of the first transactions;
apply the trained sentiment machine learning model to obtained second transaction context data associated with a second transaction conducted by a user to generate a second transaction sentiment score for the second transaction;
insert at least a portion of the second transaction context data, the second transaction sentiment score, and a unique identifier for the user included in the second transaction context data into a record of a sentiment database;
update a stored user sentiment score for the user based on the second transaction sentiment score for the second transaction conducted by the user, wherein the user sentiment score is maintained in the sentiment database associated with the unique identifier for the user;
detect a login by the user via a mobile or web application;
generate a default graphical user interface (GUI);
responsive to determining that the user sentiment score does not exceed a score threshold, output the default GUI via the mobile or web application; and
responsive to determining that the user sentiment score exceeds the score threshold:
modify the default graphical user interface (GUI) to incorporate stored digital content selected based on the user sentiment score and targeted to the user to generate a modified GUI, wherein the first digital content comprises a graphic and a hyperlink that is selectable by a user interface device to direct the user to another webpage associated with a host of the mobile or web application; and
output the modified GUI for display via the mobile or web application.

5. A system for implicit sentiment analysis to target content, the system comprising:
one or more processors; and
memory in communication with the one or more processors and storing instructions that, when executed by the one or more processors, are configured to cause the system to:
train a sentiment machine learning model based on a correlation of first transaction context data obtained for each of a plurality of first transactions with a corresponding one of a plurality of first transaction sentiment scores determined from feedback data for each of the first transactions;
apply the trained sentiment machine learning model to obtained second transaction context data associated with a second transaction conducted by a user to generate a second transaction sentiment score for the second transaction;
insert at least a portion of the second transaction context data, the second transaction sentiment score, and a unique identifier for the user included in the second transaction context data into a record of a sentiment database;
update a stored dynamic user sentiment score for the user based on the second transaction sentiment score for the second transaction conducted by the user, wherein the dynamic user sentiment score is maintained in the sentiment database associated with the unique identifier for the user;
responsive to determining that the dynamic user sentiment score does not exceed a score threshold, generate and output to the user via one or more communication networks, a default graphical user interface (GUI); and
responsive to determining that the dynamic user sentiment score exceeds the score threshold, modify, and output to the user via the one or more communication networks, the default (GUI) GUI to include digital content targeted to the user- and selected based on the dynamic user sentiment score, wherein the digital content comprises a graphic and a hyperlink that is selectable by a user interface device to direct the user to another webpage.

6. The system of claim 5, wherein the instructions, wherein the instructions, when executed by the one or more processors, are further configured to cause the system to:
determine that the dynamic user sentiment score exceeds the score threshold after detecting a login by the user via a mobile or web application.

7. The system of claim 1, wherein the instructions, when executed by the one or more processors, are further configured to cause the system to determine that the dynamic user sentiment score is within the score range based on a sentiment trend determined based on a plurality of stored historical user sentiment scores for the user.

8. The system of claim 3, wherein the instructions, when executed by the one or more processors, are further configured to reduce the dynamic user sentiment score by a first value to update the dynamic user sentiment score, when the chargeback is a merchant-initiated chargeback.

9. The system of claim 8, wherein the instructions, when executed by the one or more processors, are further configured to reduce the dynamic user sentiment score by a second value to update the dynamic user sentiment score, when the chargeback is an institution-initiated chargeback, wherein the second value is greater than the first value.

10. The system of claim 1, wherein the second transaction context data further comprises one or more of an indication of a merchant, a transaction category, a transaction type, a transaction date, a transaction time, a transaction amount, or a gratuity amount.

11. The system of claim 1, wherein the second transaction context data comprises an indication of a merchant and a type of the second transaction, wherein the type of the second transaction comprises a purchase, and wherein the instructions, when executed by the one or more processors, are further configured to determine a frequency of purchases by the user with respect to the merchant based on third transaction context data in a plurality of historical records associated with the user in the sentiment database.

12. The system of claim 11, wherein the sentiment machine learning model is configured to generate a positive transaction sentiment score based on the frequency.

13. The system of claim 11, wherein the sentiment machine learning model is configured to generate a neutral transaction sentiment score when the frequency comprises a monthly cadence.

14. The system of claim 1, wherein the instructions, when executed by the one or more processors, are further configured to, responsive to determining that the dynamic user sentiment score exceeds a score threshold, automatically adjust for the user one or more of a credit line, an interest rate, or one or more rewards program parameters.

15. The system of claim 1, wherein the instructions, when executed by the one or more processors, are further configured to generate an average user sentiment score for the user for a trailing time period based on the second transaction sentiment score and a plurality of third transaction sentiment scores in third transaction context data in a plurality of historical records in the sentiment database, wherein each of the historical records comprises the unique identifier for the user and a transaction date or time that is within the trailing time period.

16. The system of claim 15, wherein the instructions, when executed by the one or more processors, are further configured to, responsive to determining that the average user sentiment score exceeds a score threshold, automatically retrieve, and output to the user via the one or more second communication networks, stored second digital content.

17. The system of claim 4, wherein the instructions, wherein the instructions, when executed by the one or more processors, are further configured to cause the system to determine that the user sentiment score exceeds the score threshold based on a sentiment trend determined based on a plurality of stored historical user sentiment scores for the user.

18. The system of claim 4, wherein the instructions, when executed by the one or more processors, are further configured to reduce the user sentiment score by a first value to update the user sentiment score, when a type of the transaction is a merchant-initiated chargeback.
reduce the user sentiment score by a second value to update the user sentiment score, when the type of the transaction is an institution-initiated chargeback, wherein the second value is greater than the first value.

19. The system of claim 18, wherein the instructions, when executed by the one or more processors, are further configured to reduce the user sentiment score by a second value to update the user sentiment score, when the type of the transaction is an institution-initiated chargeback, wherein the second value is greater than the first value.
